(19) United States
(12) Patent Application Publication
(10) Pub. No.: US 2004/0260841 A1
(43) Pub. Date: Dec. 23, 2004

(54) Method, apparatus, and system for internet protocol communication over intelligent platform management bus

(76) Inventors: Tisson K. Mathew, Hillsboro, OR (US); Chetan Hiremath, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/465,676

(22) Filed: Jun. 19, 2003

(51) Int. Cl. G06F 15/16; G06F 15/173

(52) U.S. Cl. 709/250; 709/223

(57) ABSTRACT

A method, apparatus, and system for communicating Internet protocol formatted information across an intelligent platform management bus.

### BACKGROUND OF THE INVENTION

Server management provides tools for management of multiple integrated servers. A server management system may include software or firmware that manages operation of those servers, performs administrative tasks, and provides remote troubleshooting ability. Such server management has often been implemented utilizing Intelligent Platform Management (IPMI), which is a standard that provides interconnection between servers. IPMI, furthermore may utilize an Intelligent Platform Management Bus (IPMB). The IPMB, however, may not typically be used directly by Internet Protocol (IP) based applications, as is commonly desired, but rather requires a great deal of effort to port those IP based applications for use with IPMB. Thus, there is a need for a system, method, and device that transparently enables IP based communication over IPMB.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description wherein like reference numerals are employed to designate like parts or steps, when read with the accompanying drawings in which:

FIG. 1 is a block diagram of a system suitable for practicing an embodiment of the invention;

FIG. 2 is a block diagram of an IP over IPMB capable node suitable for practicing an embodiment of the invention;

FIG. 3 is illustrates protocol stacks in two IP over IPMB capable nodes in an embodiment of the invention;

FIG. 4 is a star topology IPMB network that may be utilized with an embodiment of the invention;

FIG. 5 is a shared bus topology IPMB network that may be utilized with an embodiment of the invention;

FIG. 6a illustrates a format for an IP over IPMB request in an embodiment of the invention; and

FIG. 6b illustrates a format for an IP over IPMB response in an embodiment of the invention.

### DETAILED DESCRIPTION OF THE INVENTION

Reference will now be made in detail to the preferred embodiments of the present invention, examples of which are illustrated in the accompanying drawings. It is to be understood that the Figures and descriptions of embodiments of the present invention included herein illustrate and describe elements that are of particular relevance, while eliminating, for purposes of clarity, other elements found in typical computers and computer networks.

The communication techniques provided herein solve shortcomings of certain networks, wherein IP based communication is desired between devices over an IPMB. Those of ordinary skill in the art will readily appreciate that the communication techniques, while described in connection with TCP based applications, is equally applicable to other applications including, for example, UDP applications. Other details, features, and advantages of the communication techniques will become further apparent in the following detailed description.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

A current version of Intelligent Platform Management Interface (IPMI) consists of three specifications: a specification for the IPMI, a specification for an Intelligent Platform Management Bus (IPMB) that may be utilized with the IPMI and a specification for an Intelligent Chassis Management Bus (ICMB) that may also be utilized with the IPMI. Those specifications are available at developer.intel.com/design/servers/ipmi, and were published Sep. 16, 1998.

The IPMI specification defines the messages and system interfaces to platform management hardware. The IPMI standard further defines common commands, data structures, and message formats for interfaces in IPMI. IPMI also defines common management functions such as how a System Event Log and Sensor Data Records are managed and accessed, how the system interfaces work, how sensors operate, how control functions such as system power on/off and reset are initiated, and how the IPMI host system watchdog timer function operates.

The IPMB specification defines an internal management bus for extending platform management within a chassis. The IPMB typically is used to link chassis management features with a motherboard management subsystem. The IPMB Address specification specifies how devices are allocated addresses on an IPMB. The IPMB Address Field Replaceable Unit (FRU) specification specifies the storage format for Field Replaceable Unit information and the Platform Event Trap (PET) format specification defines the format for local area network alerts.

A certain IPMB is based on a 2-wire serial bus that provides a standardized interconnection between different devices, or boards, or blades within a chassis. Devices within a chassis will also be referred to herein as blades or boards because blades or boards are common examples of devices communicating over IPMI. The IPMB may also serve as a standardized interface for auxiliary devices.

The ICMB specification defines an external management bus between multiple host systems and peripheral chassis.

IPMI defines common interfaces to certain hardware that is used to monitor server physical characteristics, such as temperature, voltage, fan operation, power supply operation, and chassis integrity. Those monitoring abilities provide information that enables system management, failure recovery, and device monitoring. Management features may include, for example, automatic alerting, automatic system shutdown and restart, remote restart, and power control. Such abilities and flexibility have furthermore been found to result in lower cost of operation and more convenient operation.

IPMI may specify common, abstracted, message-based interfaces to a management micro-controller. That in turn may permit the isolation of software from hardware. IPMI may also specify commands and sensor data records that describe the number and type of monitoring and control capabilities of a platform. That allows software to discover and automatically adapt to the monitoring and control features of the platform.

Server Management may provide capabilities for server management including, for example, high availability infrastructure that aims to keep a system operational at all times, often through backup and failover processing and data storage and access; electronic keying that may require replacement of a device with another device of the same series or revision to permit the device to work on a network; network provisioning systems that may provide customer services, log transactions, carry out requests, and update files; fault tolerance; failure analysis; trending; and deployment of operating systems and software. Much of the software and firmware that perform server management functions, however, are TCP/IP based, require connectivity through, for example, Ethernet, Asynchronous Transfer Mode (ATM), or Dial-up between devices or blades and the server management system, and do not function seamlessly on the IPMB.

In the IPMI environment, the communication channel between devices or blades is IPMB. For example, a TCP/IP based application that operated over Ethernet could not previously be used without customization to perform management functions because that application would not communicate directly over IPMI or the devices could not communicate over TCP/IP. Efforts to port such TCP/IP based applications to use IPMB directly have been found to require a great deal of design, development, integration, and testing. Such porting also typically requires defining a large number of additional IPMI commands, making the IPMI system very complex.

A modular and application transparent approach to enable IP based communication between devices over IPMB is therefore contemplated. In an embodiment, that approach includes a method for converting internet protocol formatted information to intelligent platform management interface formatted information. That method includes reading payload data, a transmitting node address, and a receiving node address from an internet protocol packet. That method also includes writing the transmitting node address, the receiving node address, and at least a portion of the payload data, to an intelligent platform management bus formatted packet.

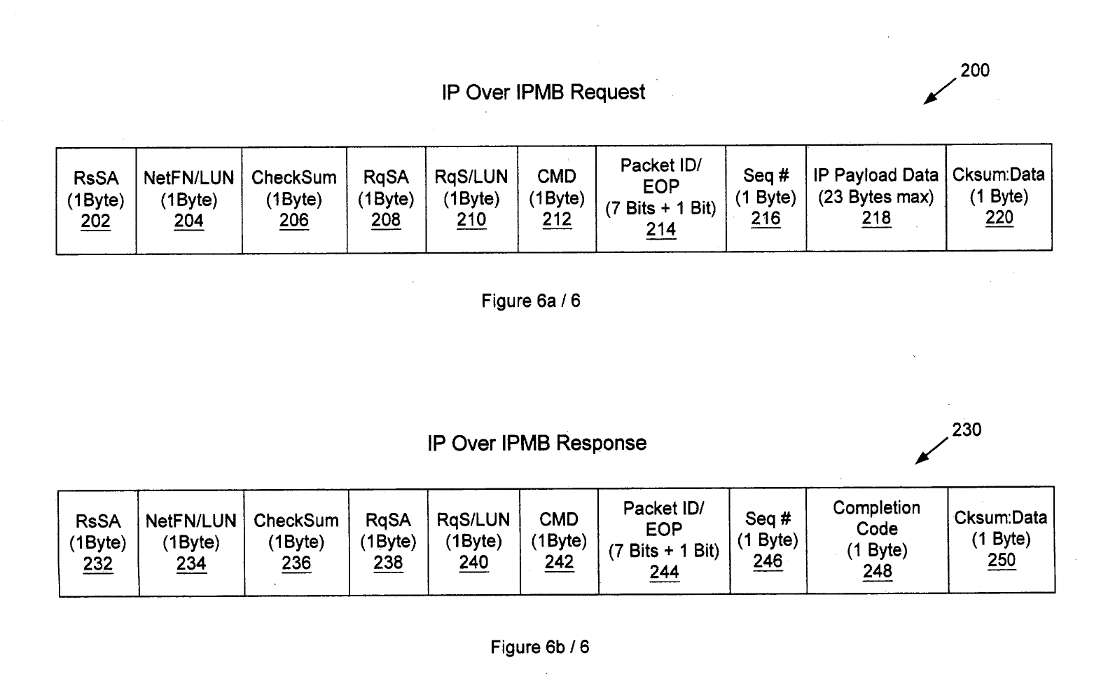

Payload data, as used herein, includes information that is desired to be communicated to the receiving node and does not include header information or information utilized to transmit, receive, assemble, and confirm the accuracy of the payload data. In certain embodiments, payload data contained in an IP packet may exceed the quantity of payload data that can fit into an IPMB packet. Thus, IP payload data that does not fit into a first IPMB packet may be placed in one or more second IPMB packets, along with the transmitting node address and the receiving node address. Additional data may also be placed in the IPMB packet as is described in connection with FIGS. 6a and 6b.

Moreover, the transmitting node address and receiving node address may be addresses assigned for a particular system, such as an IP system or an IPMI system, thus it may be necessary to cross reference one or more of those addresses to find a hardware address for the transmitting node and the receiving node before transmitting a request or response packet.

In an embodiment, a method for converting intelligent platform management bus formatted information to Internet protocol formatted information is contemplated. That method may include reading payload data, a transmitting node address, and a receiving node address from an intelligent platform management bus packet and writing the payload data, the transmitting node address, and the receiving node address to an internet protocol formatted packet.

A method of transmitting a data payload contained in an internet protocol packet over an intelligent platform management bus is also contemplated. That method may include placing the data payload from the internet protocol packet in at least one intelligent platform management bus packet, placing an address of the transmitting node in each of the intelligent platform management bus packets, placing an address of the receiving node in each of the intelligent platform management bus packets, and transmitting each of the intelligent platform management bus packets from a transmitting node to a receiving node across an intelligent platform management bus.

A method of receiving a data payload contained in an intelligent platform management bus packet over an intelligent platform management bus is also contemplated. That method may include receiving the data payload in an intelligent platform management bus packet at a receiving node and placing the data payload from the intelligent platform management bus packet in at least one internet protocol packet.

An internet protocol to intelligent platform management interface bridge is also contemplated. That IP to IPMI bridge may include an Ethernet adaptor, an intelligent platform management bus adaptor, and circuitry. The circuitry may furthermore receive internet protocol formatted information from the Ethernet adaptor, place that information in intelligent platform management interface format, and transmit the intelligent platform management interface formatted information on the intelligent platform management bus adaptor.

In addition, an intelligent platform management interface to internet protocol bridge is contemplated. That IPMB to IP bridge may include an Ethernet adaptor, an intelligent platform management bus adaptor, and circuitry. That IPMB to IP bridge circuitry may receive intelligent platform management interface formatted information from the intelligent platform management bus adaptor, place that information in internet protocol format, and transmit the Internet protocol formatted information on the Ethernet adaptor.

The network in which the IP over IPMB communication system is implemented may be a network of nodes such as computers, dumb terminals, boards or blades in a chassis or other, typically processor-based, devices interconnected by one or more forms of communication media. The communication media coupling those devices include, for example, twisted pair, co-axial cable, optical fibers and wireless communication methods such as use of radio frequencies.

Network nodes may be equipped with the appropriate hardware, software or firmware necessary to communicate information in accordance with one or more protocols. A protocol may comprise a set of instructions by which the information is communicated over the communications medium. Protocols are, furthermore, often layered over one another to form something called a “protocol stack.”

In one example embodiment the network nodes operate in accordance with a modified seven layer Open Systems Interconnect (“OSI”) architecture. The OSI architecture includes (1) a physical layer, (2) a data link layer, (3) a network layer, (4) a transport layer, (5) a session layer, (6) a presentation layer, and (7) an application layer.

The physical layer is concerned with electrical and mechanical connections to the network and may, for example, be performed by a token ring or Ethernet bus in a standard OSI architecture. The data link layer arranges data into frames to be sent on the physical layer and may receive frames. The data link layer may receive acknowledgement frames, perform error checking and re-transmit frames not correctly received. The data link may also be performed by the bus handling the physical layer. In the modified OSI architecture, IPMB may perform the physical and data link layer functionality.

The network layer determines routing of packets of data and may be performed by, for example, Internet Protocol (IP) as defined by IETF standard 5, RFC 791 (IP, Specification), adopted in September 1981 and available from www.ietf.org. The transport layer establishes and dissolves connections between nodes. The transport layer function is commonly performed by a packet switching protocol referred to as the Transmission Control Protocol (TCP). TCP is defined by the Internet engineering Task Force (IETF) standard 7, Request for Comment (RFC) 793, adopted in September 1981 (TCP Specification). The network and transport layers are often referred to collectively as “TCP/IP.”

In one embodiment of the invention, the network nodes operate in accordance with a packet switching protocol referred to as the User Datagram Protocol (UDP) as defined by the Internet Engineering Task Force (IETF) standard 6, Request For Comment (RFC) 768, adopted in August, 1980 (“UDP Specification”), and the Internet Protocol (IP) as defined by the IETF standard 5, RFC 791 (“IP Specification”), adopted in September 1981, both available from “www.ietf.org.”

UDP is a network communications protocol that offers lesser services than TCP. For example, UDP may provide port numbers to distinguish different user requests and a checksum to verify that data arrived intact. UDP may, however, not provide sequencing of the packets or retransmission of unreceived packets. After the packets are created in either UDP or TCP, the IP layer prepares the packets for transmission across a network such as the Internet.

The session layer establishes a connection between processes on different nodes and handles security and creation of the session. The presentation layer performs functions such as data compression and format conversion to facilitate systems operating in different nodes. The application layer is concerned with a user view of network data, for example, formatting electronic messages. In certain TCP/IP platforms, the functionality of the session layer, the presentation layer, and the application layer are all performed by the application.

A packet is a unit of data to be transported, includes a source node address and a destination node address, and typically exists at the network layer or above. A frame includes a packet and a header and, possibly, a trailer or other information, and typically exists at the data link layer. Packet size may be determined at the transport layer and frame size determined at the data link layer. Data that is larger than may be contained in a single packet or frame may be split into multiple packets and frames. The maximum and minimum sizes of those frames that make up, for example one complete transmission data set, may then be determined.

In the present embodiment, “transmitting nodes” and “receiving nodes” may be nodes coupled to a network such as, for example, local area network and that communicate with other processors on the network via an IPMB. Those nodes may also, in certain instances, communicate via, for example, Ethernet or ATM. Transmitting entities and receiving entities may also be nodes coupled to a common chassis and that communicate with other processors in the chassis via an internal bus.

Nodes may operate as source nodes, destination nodes, intermediate nodes or a combination of those source nodes, destination nodes, or intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include application related data, electronic mail (“email”) message data, graphics, image, video, text and so forth.

A network having a transmitting node and a receiving node is contemplated. The transmitting node is coupled to the network and transmits one or more packets containing a data payload. The receiving node is also coupled to the network. The receiving node receives the packets transmitted by the transmitting node.

In an embodiment, the network includes a transmitting node coupled to the network by an intelligent platform management bus and a receiving node coupled to the network by an intelligent platform management bus. The transmitting node may transmit on the intelligent platform management bus a plurality of intelligent platform management bus packets containing data created by an application executing in the transmitting node. That data may furthermore be read from internet protocol packets. The receiving node may receive the plurality of intelligent platform management interface packets transmitted by the transmitting node and place data from the intelligent platform management interface packets into internet protocol packets for use by an application executing in the receiving node. The transmitting node and receiving node may have processors that contain instructions which, when executed by the processor cause the processors to perform those functions.

An article of manufacture having a computer readable medium having stored thereon instructions that may be executed by a processor is also contemplated. When executed by the processor, those instructions may cause the processor to read payload data, a transmitting node address, and a receiving node address from an internet protocol packet and write the transmitting node address, and the receiving node address, and at least a portion of the payload data to an intelligent platform management interface formatted packet.

TCP/IP and UDP/IP based applications, for example, can utilize an IP based communication infrastructure to communicate between devices in a network. The proposed system is expected to permit TCP/IP, UDP/IP and other IP based applications using IP over IPMI to communicate seamlessly between devices on an IPMI network without requiring changes to those applications. While examples may be based on IPv6, it is contemplated that the present IP over IPMI system may operate with other versions of IP.

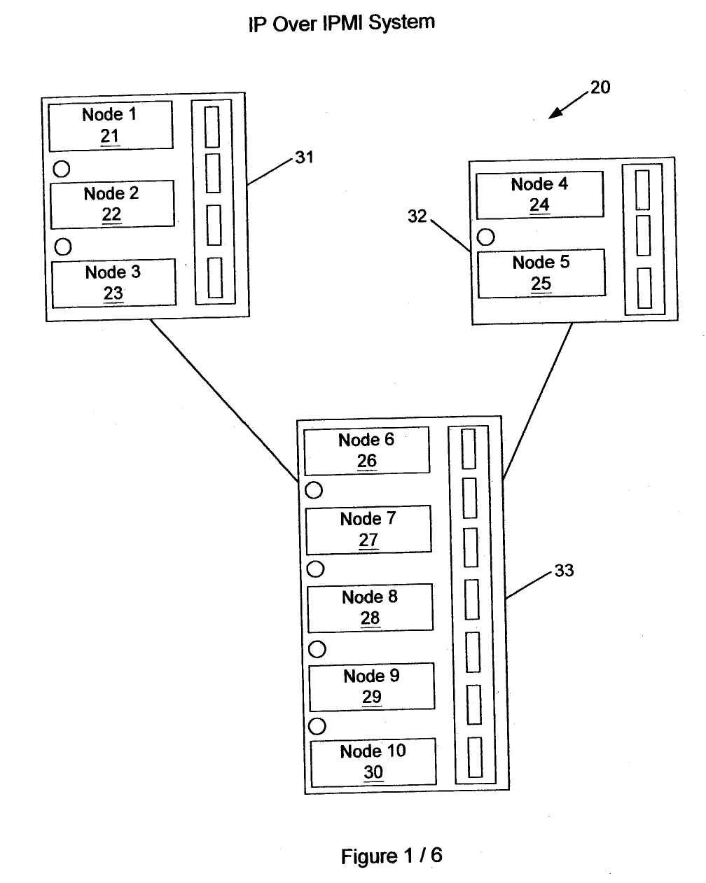

FIG. 1 illustrates an IP over IPMI system 20 in which embodiments of the present invention may be implemented. Node 1 21, node 2 22 and node 3 23 are nodes in chassis 1 31 of the IP over IPMI system 20. Node 4 24 and node 5 25 are nodes in chassis 2 32 of the IP over IPMI system 20. Node 6 26, node 7 27, node 8 28, node 9 29, and node 10 30 are nodes in chassis 3 33 of the IP over IPMI system 20.

The network nodes 21-30 may be equipped with appropriate hardware, firmware, or software to communicate information in accordance with one or more protocols including IP and IPMI protocols. Embodiments of the present invention, therefore, provide apparatuses, systems, and methods for IP over IPMB communication.

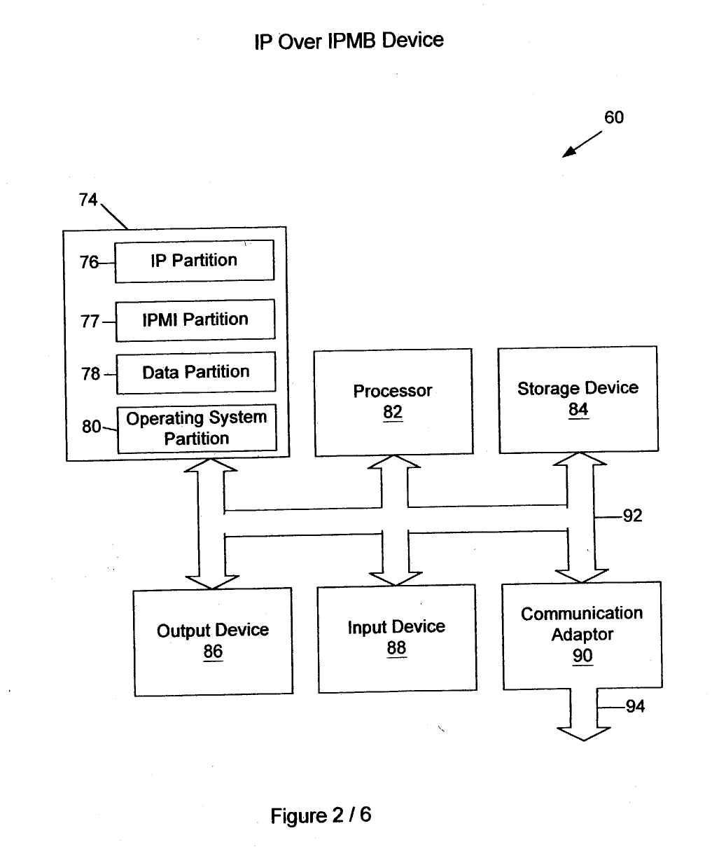

FIG. 2 illustrates an IP over IPMB capable device 60 that may communicate data between IP or IPMB networks. The IP over IPMB capable device 60 includes memory 74, a processor 82, and a communication adaptor 90. Communication between the processor 82 and the communication adaptor 90 is accomplished by way of a communication bus 92. The IP over IPMI capable device 60 may also include a storage device 84, an output device 86, an input device 88, and other devices desired.

The memory 74 may, for example, include random access memory (RAM), dynamic RAM, and/or read only memory (ROM) (e.g., programmable ROM, erasable programmable ROM, or electronically erasable programmable ROM) and may store computer program instructions or information. The memory may furthermore be partitioned into sections including an operating system partition in which operating system 80 instructions are stored, a data partition 78 in which data is stored, an IP partition 77 in which instructions for performing IP functions are stored, and an IPMI partition 76 partition in which instructions for performing IPMI functions are stored. The IP partition 77 and IPMI partition 76 may store program instructions and allow execution by the processor 82 of the program instructions. The data partition 78 may furthermore store data to be used during the execution of the program instructions.

The processor 82 may, for example, be an Intel® Pentium® type processor or another processor manufactured by, for example Motorola®, Compaq®, AMD®, or Sun Microsystems®. The processor 82 may furthermore execute the program instructions and process the data stored in the memory 74. In one embodiment, the instructions are stored in memory 74 in a compressed and/or encrypted format. As used herein the phrase, “executed by a processor” is intended to encompass instructions stored in a compressed and/or encrypted format, as well as instructions that may be compiled or installed by an installer before being executed by the processor.

The storage device 84 may, for example, be a magnetic disk (e.g., floppy disk and hard drive), optical disk (e.g., CD-ROM) or any other device or signal that can store digital information.

The communication adaptor 90 permits communication between the IP over IPMB capable device 60 and other devices or nodes coupled to the communication adaptor 90 at the communication adaptor port 94. The communication adaptor 90 may be a network interface that transfers information from nodes on a network to the IP over IPMB capable device 60 or from the IP over IPMB capable device 60 to nodes on a network. The network may be, for example, a local area network, a wide area network, or the network 50 illustrated in FIG. 1. It will be recognized that the IP over IPMB capable device 60 may alternately or in addition be coupled directly to one or more other devices through one or more input/output adaptors (not shown) or through a bus in a chassis (not shown).

The IP over IPMB capable device 60 may also be coupled to other output devices such as, for example, a printer or a monitor, and various input devices 88 such as, for example, a keyboard or mouse. It will be recognized, however, that the IP over IPMB capable device 60 does not necessarily need to have any input device 88 or any output device 86 to operate. Moreover, the storage device 84 may also not be necessary for operation of the IP over IPMB capable device 60.

The elements 74, 82, 84, 86, 88, and 90 of the IP over IPMB capable device 60 may communicate by way of one or more communication busses 92. Multiple IP over IPMB capable devices 60 may furthermore communicate by way of those busses 92 where, for example, those devices are coupled to a common chassis. Those busses 92 may include, for example, a system bus, a peripheral component interface bus, and an industry standard architecture bus.

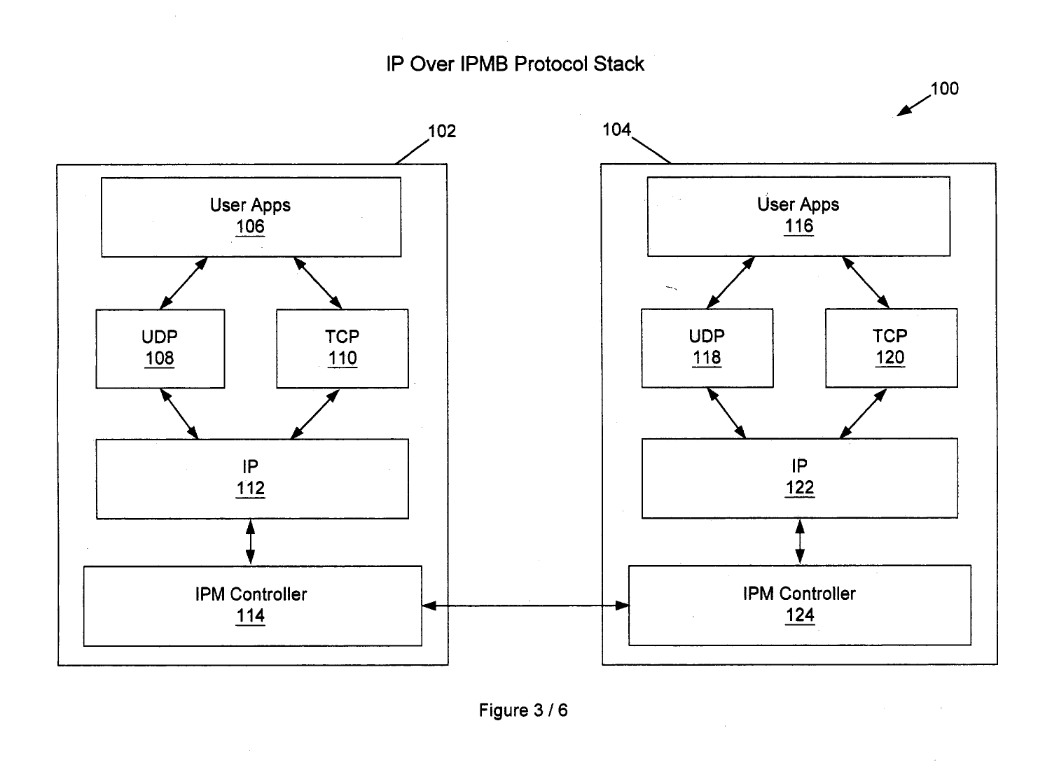

FIG. 3 illustrates an IP over IPMB protocol stack 100. The IP over IPMB protocol stack 100 may include a first device 102 and a second device 104. The first device 102 includes user applications 106 that communicate through a UDP layer 108 or a TCP layer 110. The UDP layer 108 and TCP layer 110, in turn, communicate with an IP layer 112. The IP layer 112 also communicates with an IPM controller 114. The second device 104 similarly includes user applications 116 that communicate through a UDP layer 118 or a TCP layer 120. The UDP layer 118 and TCP layer 120, in turn, communicate with an IP layer 122. The IP layer 122 also communicates with an IPM controller 124. The first device IPM controller 114 and second device IPM controller 124, furthermore communicate over an IPMB. Thus the IPMB may provide the data link layer and the physical layer of a protocol stack.

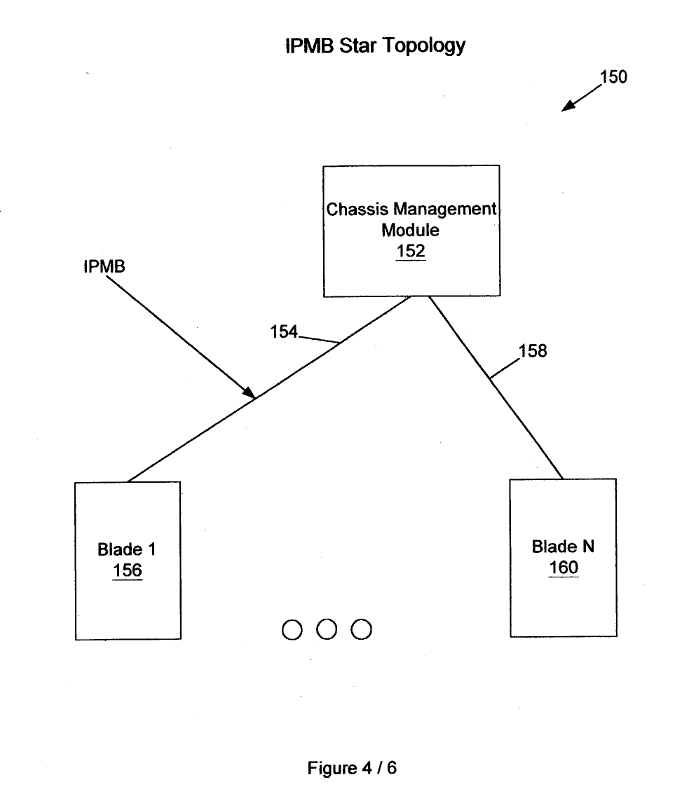

FIG. 4 illustrates an IPMB coupled system utilizing a star topology 150. In that IPMB coupled system utilizing a star topology 150, a chassis management module 152 having an IPMB address of 20 h is coupled separately, in star topology, to a plurality of blades comprising an IPMB system. In FIG. 4, a first IPMB leg 154 couples the chassis management module 152 to a first blade 156 and a second IPMB leg 158 couples the chassis management module 152 to a last blade 160. Additional blades (not shown) may similarly be coupled to the chassis management module.

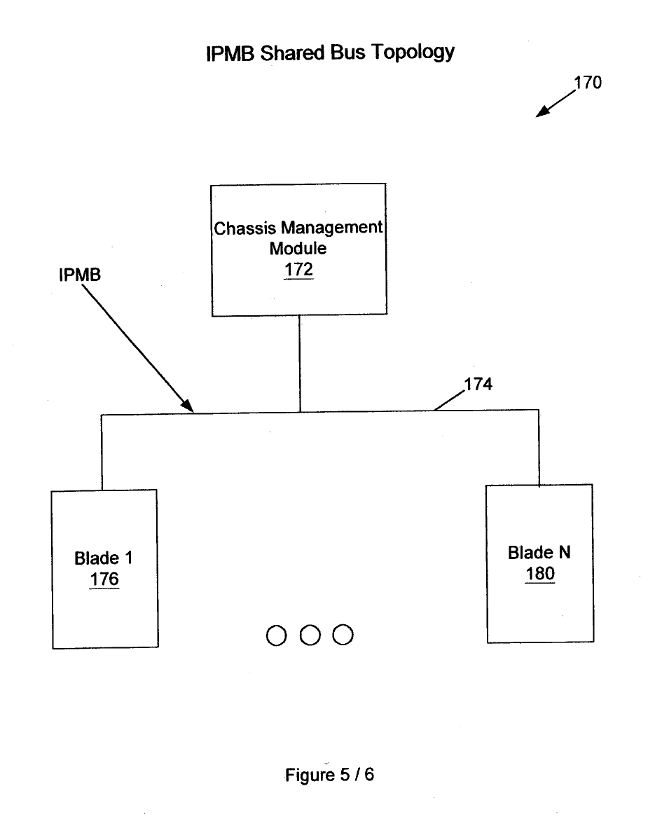

FIG. 5 illustrates an IPMB coupled system utilizing a shared bus topology 170. In that IPMB coupled system utilizing a shared bus topology 170, a chassis management module 172 having an IPMB address of 20 h is coupled to a common IPMB 174 that, in turn is coupled to a plurality of blades comprising an IPMB system. In FIG. 5, the IPMB 174 is coupled to the chassis management module 172, to a first blade 176, to a last blade 180, and may be coupled to additional blades (not shown).

An IP over IPMB enabled IPM controller, such as the chassis management module 152 illustrated in FIG. 4 or the chassis management module 172 illustrated in FIG. 5, may include a mechanism that dynamically determines hardware addresses associated with IP addresses.

In a certain IPMB network, address 0×20 h is reserved for a main controller of the network. Typically, a single main controller exists in each network. Each IP over IPMB enabled node may register its IP address with the main controller, and may identify the main controller by its address. The main controller will, in turn, maintain an IP to IPMB address map table. That IP to IPMB address map table may contain and correlate IP addresses and hardware addresses of nodes in the network. As an alternative, the main controller may return the hardware address of an IPM controller that is tasked with maintaining the address mappings. That may help in keeping the address resolution tables distributed and minimize the harm of a single point failure. The nodes that keep the address resolution tables can also be replicated in multiple nodes to minimize the harm of a single point failure. Nodes may furthermore maintain a local table of IP addresses correlated to IPMB addresses or may query the main controller for the hardware address for a particular IP address.

Thus, a node initiating IP over IPMB communication to another node may query the main controller for the address of that other node or select the IPMB address of that other node from a local table. If the main controller is queried, the main controller can respond to the address request by providing the hardware address of that requested node or point the requesting node to the IPM controller that has a map containing the hardware address of the requested node.

To keep address resolution traffic to a minimum, local nodes may maintain a map correlating IP addresses and hardware addresses of nodes that those local nodes have been in contact with recently and the main controller may maintain a complete correlation map, thus utilizing a hybrid system wherein the correlation maps are maintained both at a main controller and locally in the various nodes of the network. The correlation maps maintained at the individual nodes may contain addresses of other nodes as they are accessed by that node and those node addresses may be aged out of the map if they are not used for a predetermined period of time. When a node is to be contacted that is contained within an individual node correlation map, that node may communicate directly with the receiving node without accessing the main controller. When a node is to be contacted that is not contained within an individual node, that transmitting node may communicate with the main controller and retrieve the desired receiving node address therefrom.

To contact a node outside an IPMB network, the main controller may provide a route to a node that bridges the initiating node to the network to be contacted.

FIGS. 6a and 6b illustrate an embodiment of formatting IP over IPMB request and response packets. FIG. 6a depicts an embodiment of the format of an IP over IPMB request 200. In that embodiment, the IPMB request includes a responder slave address 202 indicated by “RsSA” and occupying one byte, a network function of the message 204 indicated by “NetFN/LUN” and occupying one byte, a checksum 206 occupying one byte, a requestor slave address 208 indicated by “RqSA” and occupying one byte, a requestor slave sequence number 210 indicated by “RqS/LUN” and occupying one byte, a command 212 indicated by “CMD” and occupying one byte, a packet identifier and end of packet marker 214 indicated by “Packet ID/EOP” and occupying eight bits, a sequence number 216 indicated by “Seq#” and occupying one byte, IP payload data 218 that may occupy a maximum of 23 bytes and contain a portion of the message being passed between nodes, and a data checksum 220 indicated by “Cksum:Data” and occupying one byte.

The responder slave address 202 indicates the destination IPMB address. The network function of the message 204 indicates whether the message is a request or a response by, for example, including an even value for all request and an odd value for all responses. The checksum 206 is utilized to assure the integrity of the packet. The requestor slave address 208 indicates the source IPMB address. The requester slave sequence number 210 may include six bits from the requestor slave and an eight bit sequence number such that the requester slave sequence number 210 would utilize 14 bits. The requestor slave sequence number 210 may then increment from 0 to 16384 and then wrap-around back to 0. The command 212 can be a standard command or an implementation specific command, such as an OEM IPMI command. The packet identifier may utilize the first 7 bits of the packet identifier and end of packet marker 214 and may vary from 0-128 and wrap back to 0. The end of packet marker may utilize the 8^{th} bit of the packet identifier and end of packet marker 214. For example, a zero in the end of packet marker bit might indicate that the end of the IP payload packet has not yet been reached and a one in the end of packet marker bit might indicate that the end of the IP payload packet has yet been reached. The data checksum 220 is a checksum of the payload data and does not include the header.

As may be seen in FIG. 6b, an embodiment of the IP over IPMB response 230 includes the same data as the IP over IPMB request 200 with one exception. In that embodiment, the IPMB response 230 includes a responder slave address 232 indicated by “RsSA” and occupying one byte, a network function of the message 234 indicated by “NetFN/LUN” and occupying one byte, a checksum 236 occupying one byte, a requester slave address 238 indicated, by “RqSA” and occupying one byte, a requestor slave sequence number 240 indicated by “RqS/LUN” and occupying one byte, a command 242 indicated by “CMD” and occupying one byte, a packet identifier and end of packet marker 244 indicated by “Packet ID/EOP” and occupying one byte, a sequence number 246 indicated by “Seq#” and occupying one byte, a completion code 248 occupying one byte and containing the status of the IP over IPMB request 200, and a data checksum 220 indicated by “Cksum:Data” and occupying one byte.

Thus, the IPMB response packet format is a mirror image of the IPMB request packet with one exception. Rather than having IP payload data 218, the IP over IPMB response 230 includes a completion code that may be one byte in length.

TCP/IP or UDP/IP information may, thus, be transmitted over an IPMB by converting that information from TCP/IP or UDP/IP formats to IPMB request and response formats 200 and 230 such as those illustrated in FIGS. 6a and 6b. Such conversion may occur within a transmitting node for direct transmission of information from a transmitting node to a receiving node. Alternately, that conversion may occur by transmitting information in, for example, TCP/IP or UDP/IP format to a bridge, converting that information to IPMB format at the bridge, and transmitting the IPMB formatted information from the bridge over the IPMB to the receiving node.

Since the maximum message size of a current IPMB packet is limited to 32 bytes, IP packets containing TCP or UDP information that is longer than what will fit in a single IPMB packet may be fragmented and transmitted in multiple frames from the transmitting node. The receiving node may then reassemble the information from the multiple fragmented frames upon receipt of those frames.

Thus, in an embodiment of the IP over IPMB communication corresponding to the IP over IPMB packet formats illustrated in FIGS. 6a and 6b, IP payloads of more than 23 bytes are fragmented into units of 23 bytes or less. The transmitting node queries the receiving node for a window size at which the receiving node may receive frames. The receiving node responds with the number of 23 byte pieces of information it can accept (referred to hereinafter as “x”). The transmitting node may then pause after sending x packets to, for example, permit the receiving node to process inbound data and push that data to the IP layer of the receiving node. That pause may be handled by, for example, polling or interrupt. That pause may also coincide with resending the window size query, which may be performed after each transmission of x frames.

In an embodiment, the sending node transmits x frames to the receiving node without waiting for a response from the receiving node between those frames. The sequence number is incremented for each frame transmitted. The receiving node processes each frame and responds to every frame it receives. The transmitting node waits for 250× ms for responses from the receiving node for each frame sent. If a response is received at the transmitting node for each frame sent, the transmitting node proceeds to transmit the next set of x frames. If a response is not received at the receiving node, then the transmitting node will re-transmit the frames for which no response was received. The transmitting node will then proceed to transmit the next set of x frames after it receives a response for each frame previously sent. It is contemplated that a sliding window type of transmission might also be used to achieve improved throughput and flow control.

Since IPMB bandwidths are in the order of 100 Kbps, special considerations can be used for interactive traffic that would send many small IP frames across the IPMB. To improve the performance of low bandwidth networks, compression of IP datagrams can be used to reduce the size of the payload data. That strategy not only reduces the quantity of the data transmitted, it may also provide a level of security, depending on the compression mechanism utilized.

IP over IPMI propagation delay will now be considered. Assuming for the sake of an example a quantity of IP data, expressed as Y, is to be transmitted across the IPMB. Further assuming that a maximum payload of 23 bytes may be transmitted in a frame and an IPMB bandwidth of 100 Kbits/sec, then a total propagation delay of 2.56 milliseconds may be calculated by multiplying the number of bytes per frame (32 bytes) by the number of bits per byte (8 bits/byte) and dividing that by the bandwidth (100 times 1000 bits/sec). Thus, an IP payload (Y) of 1 KB could be send across that IPMB in 114 ms. That may be calculated by dividing the number of bytes in a 1 KB payload (1024 bytes) by the number of bytes for payload in a frame (23 bytes) and multiplying that by the propagation delay (2.56 milliseconds).

IP over IPMI queuing delay is also a factor in total delay. Queuing delay is dependent on the buffer size of the receiving node and the speed at which the receiving node can process data. Recognizing that a normal queuing delay for an IPMB packet is 5-10 ms, we will assume a queuing delay of 7.5 milliseconds per IPMB packet.

According to an IPMB protocol, the response waiting time is 250 ms. Since the requests are transmitted asynchronously in the frames, and if a buffer size of at least 8 KB is available at the receiving node, the collective response waiting time is insignificant.

Total delay may be defined as propagation delay plus queuing delay plus a response waiting time. It may therefore be calculated that, for the example described above, the total delay for a frame is 2.56 ms+7.5 ms or 10.06 ms. Thus, a 1 KB IP payload can be sent across the IPMB in approximately 450 ms (1024 bytes/23 bytes per packet * 10.06 ms=approximately 450 ms).

As for how bridging may be accomplished between IP and IPMB layers, it is contemplated that any node that includes IP functionality and IPMB functionality may transfer information in, for example, packets between the IP and IPMB layers. In the following example, a node has the capability to communicate over an Ethernet bus, although another bus, such as an ATM bus may provide similar functionality. The node also has IPMB capability. Such a node having IP and IPMB functionality will be referred to hereinafter as a “bridge.” Such a bridge may receive information in a TCP/IP or UDP/IP format, place that information into an IPMB format such as those shown in FIGS. 6a and 6b, and transmit that information to another mode in IPMB format. The bridge may determine an address of a desired receiving node from, for example, a transmitting node or a main controller containing an IP to IPMB map. If the bandwidth of the IP network is significantly greater than the bandwidth of the IPMB network, then buffering of IP packets by the bridge might be required to prevent the IPMB network from being flooded with messages that the receiving node cannot process. IPMB to IP communication may also be accomplished in the same or a different bridge device.

While the systems, apparatuses, and methods of communicating IP data over an IPMB have been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A protocol stack for a computer communication network, comprising:
an internet protocol layer; and
an intelligent platform management interface layer communicating with the internet protocol layer.

2. The protocol stack of claim 1, wherein the internet protocol layer and intelligent platform management interface layer are implemented in at least two processors.

3. The protocol stack of claim 2, wherein the two processors communicate on an intelligent platform management bus.

4. The protocol stack of claim 1, further comprising a transmission control protocol layer communicating with the internet protocol layer.

5. The protocol stack of claim 4, further comprising an application protocol layer communicating with the transmission control protocol layer

6. The protocol stack of claim 1, further comprising a user datagram protocol layer communicating with the internet protocol layer.

7. The protocol stack of claim 6, further comprising an application protocol layer communicating with the user datagram protocol layer.

8. A method for converting internet protocol formatted information to intelligent platform management bus formatted information, comprising:
reading payload data, a transmitting node address, and a receiving node address from an internet protocol packet; and
writing the transmitting node address, the receiving node address, and at least a portion of the payload data to an intelligent platform management bus formatted packet.

9. The method of claim-8, further comprising writing payload data not written to the intelligent platform management interface formatted packet to a second intelligent platform management interface formatted packet and writing the transmitting node address and the receiving node address to the second intelligent platform management interface formatted packet.

10. The method of claim 8, further comprising correlating the transmitting node address to a hardware address associated with the transmitting node and correlating the receiving node address to a hardware address associated with the receiving node.

11. The method of claim 8, further comprising:
writing an indication of whether the packet is a request or-a response to the intelligent platform management interface packet;
writing a header checksum to the intelligent platform management interface packet;
writing a sequence number indicating the order in which packets fall to the intelligent platform management interface packet; and
writing a payload data checksum to the intelligent platform management interface packet.

12. A method for converting intelligent platform management bus formatted information to internet protocol formatted information, comprising:
reading payload data, a transmitting node address, and a receiving node address from an intelligent platform management interface packet; and
writing the transmitting node address, and the receiving node address, and at least a portion of the payload data to an internet protocol formatted packet.

13. The method of claim 12, further comprising correlating the transmitting node address to a hardware address associated with the transmitting node and correlating the receiving node address to a hardware address associated with the receiving node.

14. The method of claim 12, further comprising:
writing an indication of whether the packet is a request or a response to the internet protocol packet;
writing a header checksum to the internet protocol packet;
writing a sequence number indicating the order in which packets fall to the internet protocol packet; and
writing a payload data checksum to the internet protocol packet.

15. A method of transmitting a data payload contained in an internet protocol packet over an intelligent platform management bus, comprising:
placing the data payload in at least one intelligent platform management bus packet;
placing an address of the transmitting node in each of the intelligent platform management bus packets;
placing an address of the receiving node in each of the intelligent platform management bus packets; and
transmitting each of the intelligent platform management bus packets from a transmitting node across an intelligent platform management bus.

16. The method of claim 15, further comprising determining a hardware address associated with the receiving node from a table.

17. The method of claim 16, wherein the table is stored in the transmitting node.

18. The method of claim 16, wherein the table is stored in a node other than the transmitting node.

19. A method of receiving a data payload contained in an intelligent platform management bus packet over an intelligent platform management bus, comprising:
receiving the data payload in the intelligent platform management bus packet at a receiving node; and
placing the data payload from the intelligent platform management bus packet in at least one internet protocol packet.

20. The method of claim 19, wherein receiving the data payload in an intelligent platform management bus packet includes determining a hardware address associated with the receiving node from a table.

21. An internet protocol to intelligent platform management interface bridge, comprising:
an Ethernet adaptor;
an intelligent platform management bus adaptor; and
circuitry that receives internet protocol formatted information from the Ethernet adaptor, places that information in intelligent platform management interface format, and transmits the intelligent platform management interface formatted information on the intelligent platform management bus adaptor.

22. The method of claim 21, wherein the circuitry writes payload data not written to the intelligent platform management interface formatted packet to a second intelligent platform management interface formatted packet and writes the transmitting node address and the receiving node address to the second intelligent platform management interface formatted packet.

23. The method of claim 21, further comprising correlating the transmitting node address to a hardware address associated with the transmitting node and correlating the receiving node address to a hardware address associated with the receiving node.

24. An intelligent platform management interface to internet protocol bridge, comprising:
an Ethernet adaptor;
an intelligent platform management bus adaptor; and
circuitry that receives intelligent platform management interface formatted information from the intelligent platform management bus adaptor, places that information in internet protocol format, and transmits the Internet protocol formatted information on the Ethernet adaptor.

25. The method of claim 24, further comprising correlating the transmitting node address to a hardware address associated with the transmitting node and correlating the receiving node address to a hardware address associated with the receiving node.

26. A network comprising:
a transmitting node coupled to the network by an intelligent platform management bus, the transmitting node transmitting on the intelligent platform management bus a plurality of intelligent platform management bus packets containing data created by an application executing in the transmitting node, that data being read from internet protocol packets; and
a receiving node coupled to the network by an intelligent platform management bus, the receiving node receiving the plurality of intelligent platform management interface packets transmitted by the transmitting node and placing data from the intelligent platform management interface packets into internet protocol packets for use by an application executing in the receiving node.

27. The method of claim 26, further comprising correlating the transmitting node address to a hardware address associated with the transmitting node and correlating the receiving node address to a hardware address associated with the receiving node.

28. An article of manufacture, comprising:
a computer readable medium having stored thereon instructions which, when executed by a processor, cause the processor to:
read payload data, a transmitting node address, and a receiving node address from an internet protocol packet; and
write at least a portion of the payload data, the transmitting node address, and the receiving node address to an intelligent platform management interface formatted packet.

29. The article of manufacture of claim 28, further comprising writing payload data not written to the intelligent platform management interface formatted packet to a second intelligent platform management interface formatted packet and writing the transmitting node address and the receiving node address to the second intelligent platform management interface formatted packet.

30. The article of manufacture of claim 28, further comprising correlating the transmitting node address to a hardware address associated with the transmitting node and correlating the receiving node address to a hardware address associated with the receiving node.
